(19) United States
(12) Patent Application Publication
(10) Pub. No.: US 2025/0341694 A1
(43) Pub. Date: Nov. 6, 2025

(54) CABLE ASSEMBLY HAVING THERMOPLASTIC OVERMOLD AND INSERT TO POSITION COMPONENTS OF THE ASSEMBLY WITHIN THE OVERMOLD

(71) Applicant: CORNING RESEARCH & DEVELOPMENT CORPORATION, Corning, NY (US)

(72) Inventors: Xiaole Cheng, Painted Post, NY (US); Sergey Vladimirovich Chernykh, Berlin (DE); Michael Todd Faulkner, Granite Falls, NC (US); Lars Kristian Nielsen, Denver, NC (US)

(21) Appl. No.: 19/265,295

(22) Filed: Jul. 10, 2025

Related U.S. Application Data
(63) Continuation of application No. PCT/US2024/022461, filed on Apr. 1, 2024.
(60) Provisional application No. 63/458,745, filed on Apr. 12, 2023.

(51) Int. Cl. G02B 6/44; B29C 45/14; B29K 101/12; B29L 11/00

(52) U.S. Cl. CPC G02B 6/4431; B29C 45/14614; B29K 2101/12; B29L 2011/0075

(57) ABSTRACT

A cable assembly in which a distribution cable contains a plurality of optical elements and has an opening formed in the distribution cable. A branch cable has a bore extending along a length thereof, and an insert is positioned in the opening of the distribution cable. At least one optical element of the plurality of optical elements extends from the distribution cable through the opening and into the bore of the branch cable. A thermoplastic overmold is formed around the opening of the distribution cable, an end of the branch cable, at least a portion of the at least one optical element, and the insert. The insert creates a gap between the distribution cable and the branch cable, filled by the thermoplastic overmold, and the insert includes a ramp surface to support the optical element in a transition from the opening into the bore of the branch cable.

### CROSS-REFERENCE TO RELATED APPLICATION

This application is a Continuation of International Patent Application No. PCT/US2024/022461, filed on Apr. 1, 2024, which claims the benefit of priority of U.S. Provisional Application No. 63/458,745, filed on Apr. 12, 2023, the content of which is relied upon and incorporated herein by reference in its entirety.

### BACKGROUND

The disclosure relates generally to an optical fiber distribution cable having a branch cable and more particularly to an overmold applied to a branch point along the optical fiber distribution cable. As optical fibers are routed through a network, they may be carried in smaller and smaller optical fiber cables. For example, a main distribution cable may include several hundreds or thousands of optical fibers, and optical fiber cables containing fewer optical fibers may branch off of the main distribution cable at various points along the length of the main distribution cable. At such branching points, the branching cables may be protected with a molding material. However, such molding materials tend to be expensive, difficult to obtain in large quantities, and have a narrow range of properties, limiting customization.

### SUMMARY

According to an aspect, embodiments of the disclosure relate to a cable assembly. The cable assembly includes a distribution cable containing a plurality of optical elements and having an opening formed in the distribution cable. The cable assembly also includes a branch cable having a bore extending along a length thereof and an insert positioned in the opening of the distribution cable. Further, the cable assembly includes a thermoplastic overmold. At least one optical element of the plurality of optical elements extends from the distribution cable through the opening and into the bore of the branch cable. The thermoplastic overmold is formed around the opening of the distribution cable, an end of the branch cable, at least a portion of the at least one optical element, and the insert. The insert creates a gap between the distribution cable and the branch cable so that the thermoplastic overmold fills the gap, and the insert includes a ramp surface to support the at least one optical element in a transition from the opening into the bore of the branch cable.

According to another aspect, embodiments of the disclosure relate to a cable assembly. The cable assembly includes a distribution cable containing a plurality of optical elements and having an opening formed in the distribution cable. The cable assembly also includes a branch cable having a bore extending along a length thereof. Further, the cable assembly includes an overmold. At least one optical element of the plurality of optical elements extends from the distribution cable through the opening and into the bore of a first end of the branch cable. The overmold is formed around the opening of the distribution cable, the first end of the branch cable, and at least a portion of the at least one optical element. The overmold is formed from a thermoplastic material comprising 30 wt % to 80 wt % of a polyolefin component and 20 wt % to 70 wt % of a thermoplastic polyolefin elastomer component.

According to a further aspect, embodiments of the disclosure relate to a method of forming an overmold around a distribution cable and a branch cable in which a first optical element extends from the distribution cable into the branch cable. In the method, a distribution cable is positioned within a mold. The distribution cable contains a plurality of optical elements, including the first optical element, and the distribution cable has an opening formed therein through which the first optical element extends. The opening is within the mold. Further, in the method, an insert is positioned within the opening. A branch cable is positioned within the mold such that an end of the branch cable abuts the insert and such that the first optical element contacts a ramp surface of the insert as the first optical element transitions from the opening to the branch cable. A thermoplastic material is injected into the mold to form the overmold around the opening of the distribution cable, the end of the branch cable, the insert, and at least a portion of the first optical element.

Additional features and advantages will be set forth in the detailed description that follows, and, in part, will be readily apparent to those skilled in the art from the description or recognized by practicing the embodiments as described in the written description and claims hereof, as well as the appended drawings.

It is to be understood that both the foregoing general description and the following detailed description are merely exemplary, and are intended to provide an overview or framework to understand the nature and character of the claims.

### BRIEF DESCRIPTION OF THE DRAWINGS

The accompanying drawings are included to provide a further understanding and are incorporated in and constitute a part of this specification. The drawings illustrate one or more embodiment(s), and together with the description serve to explain principles and the operation of the various embodiments.

FIG. 1 depicts an overmold formed around a main distribution cable and a branch cable, according to an exemplary embodiment;

FIG. 2 depicts a longitudinal cross-sectional view of the overmold around the main distribution cable and the branch cable of FIG. 1, according to exemplary embodiments;

FIGS. 3A-3C depict transverse cross-sectional views of a first side of the distribution cable, a second side of the distribution cable, and the branch cable of FIG. 1, according to an exemplary embodiment;

FIG. 4 depicts a side view of an insert used for positioning cable components during an overmolding process, according to an exemplary embodiment;

FIG. 5 depicts a perspective view of the insert of FIG. 4, according to an exemplary embodiment;

FIG. 6 depicts an overmold cable assembly, according to an exemplary embodiment;

FIG. 7 depicts an overmold of a branch cable in which a splice tube transitions to a tether, according to an exemplary embodiment;

FIG. 8 is a flow diagram of a first method for forming an overmold around a distribution cable and a branch cable, according to an exemplary embodiment; and

FIG. 9 is a flow diagram of a second method for forming an overmold around a splice tube and a tether, according to an exemplary embodiment.

### DETAILED DESCRIPTION

Referring generally to the figures, various embodiments of a cable assembly and overmold composition are provided. As will be discussed more fully below, the cable assembly includes a distribution cable containing a plurality of optical elements, and at least one branch cable containing an optical element that has split from the distribution cable. According to the present disclosure, a thermoplastic overmold is formed around the location where the branch cable extends from the distribution cable to protect the distribution cable and an end of the branch cable from environmental contamination. As compared to conventional overmold materials, the thermoplastic material of the overmold described herein is less expensive, more easily sourced, and can be formed through low-pressure injection molding processes with little waste and cure time. To accommodate the thermoplastic material of the overmold as well as the injection molding process, the present disclosure also relates to an insert that helps ensure accurate positioning of the distribution cable, branch cable, and optical elements during the injection molding process. Exemplary embodiments of the cable assembly, including the insert and the thermoplastic overmold, and method of forming same will be described in greater detail below and in relation to the figures provided herewith, and these exemplary embodiments are provided by way of illustration, and not by way of limitation.

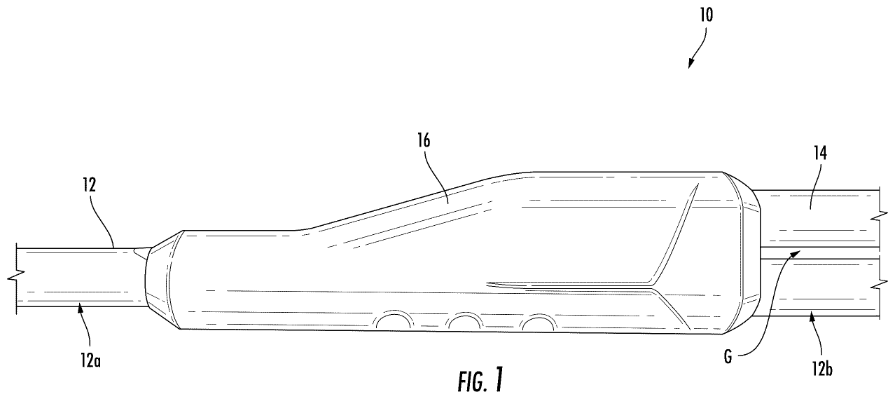

FIG. 1 depicts an embodiment of a portion of cable assembly 10. In the portion depicted, the cable assembly 10 includes a distribution cable 12 having a first side 12a and a second side 12b. The cable assembly 10 further includes a branch cable 14 extending from the distribution cable 12 between the first side 12a and the second side 12b. An overmold 16 is provided around the distribution cable 12 and the branch cable 14 at the location where the branch cable 14 extends from the distribution cable 12. Herein, the location of the overmold 16 divides the distribution cable 12 between the first side 12a (which may be considered an upstream side) and the second side 12b (which may be considered a downstream side).

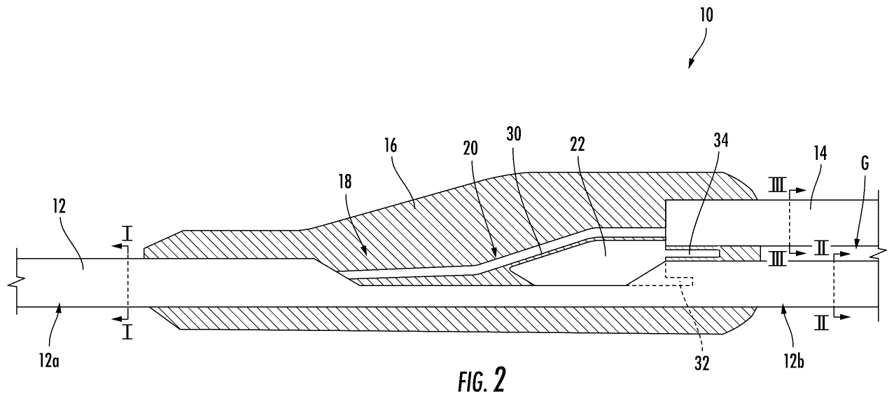

FIG. 2 depicts a cross-sectional view of the cable assembly 10 of FIG. 1 taken along the longitudinal axis of the optical assembly 10. As can be seen in FIG. 2, the distribution cable 12 includes an opening 18 through which an optical element 20 is accessed. In one or more embodiments, the optical element 20 includes at least one optical fiber. For example, the optical element 20 can be one or more optical fibers, or the optical element 20 can be an optical fiber ribbon comprising a plurality of optical fibers. At least one optical element 20 is extracted from the distribution cable 12 and directed into the branch cable 14. As will be discussed more fully below, the optical element 20 is spliced to a corresponding optical element 20 provided in the branch cable 14.

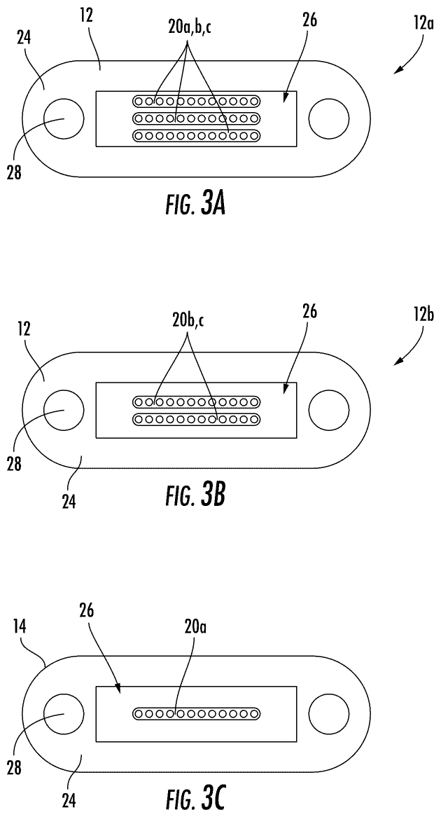

FIGS. 3A-3C depict cross-sectional views of the distribution cable 12 and the branch cable 14 showing the division of the optical elements 20 within the optical assembly 10. In FIG. 3A, the first side 12a of the distribution cable 12 includes three optical elements 20a, 20b, 20c in the form of optical fiber ribbons. The distribution cable 12 has a cable jacket 24 that includes a bore 26 extending along the longitudinal axis of the distribution cable 12. In one or more embodiments, the distribution cable 12 includes other components such as one or more strength elements 28 embedded in the cable jacket 24. In FIG. 3B, two of the optical elements 20b, 20c continue to the second side 12b of the distribution cable 12, whereas one optical element 20a is directed into the branch cable 14 as shown in FIG. 3C. In the embodiment depicted in FIGS. 3A-3C, the cable jackets 24 of the distribution cable 12 and of the branch cable 14 define a flat cable shape, but in other embodiments, the cable jacket 24 of the distribution cable 12 and the branch cable 14 may define another shape, such as a circular shape.

Returning to FIG. 2, the overmold 16 surrounds and protects the opening 18 in the distribution cable 12 and the beginning of the branch cable 14. According to embodiments of the present disclosure, the overmold 16 is formed from a thermoplastic material that can be injection molded around the distribution cable 12 and branch cable 14. In contrast to certain conventional thermosetting overmold materials, the injection molding of the molten thermoplastic material is done at relatively higher pressure and temperature. Because of this, the optical element 20 can shift out of a desired position with respect to the opening 18 and branch cable 14. Such shifting can cause the optical element 20 to bend at an undesirably sharp angle, which could cause attenuation of the optical signals carried by the optical element 20. Additionally, the branch cable 14 can shift until it abuts the distribution cable 12. However, it is desirable to maintain a gap G between the branch cable 14 and the distribution cable 12 so that the thermoplastic material of the overmold 16 fills between the branch cable 14 and the distribution cable 12 to seal the cable assembly 10 against environmental contamination, in particular water infiltration.

To prevent the optical element 20 from shifting and to maintain the gap G between the branch cable 14 and the distribution cable 12, an insert 22 is provided within the opening 18 of the distribution cable 12. As can be seen, the insert 22 provides a support for the optical element 20 to prevent the optical element from bending sharply under pressure from the molten thermoplastic material for the overmold 16. Further, the insert 22 acts as a spacer configured to maintain the gap G between the branch cable 14 and the distribution cable 12 during molding so that the molten thermoplastic material of the overmold 16 can seal between the branch cable 14 and the distribution cable 12.

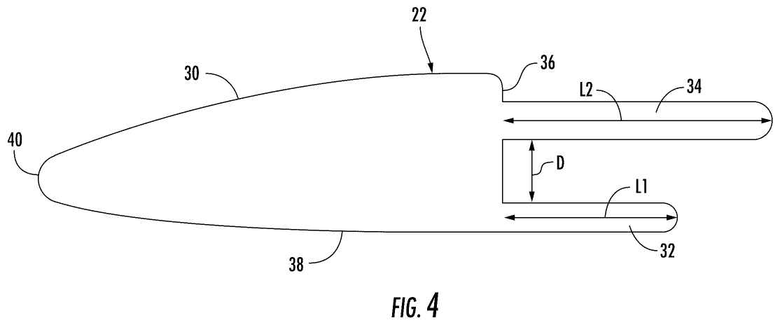

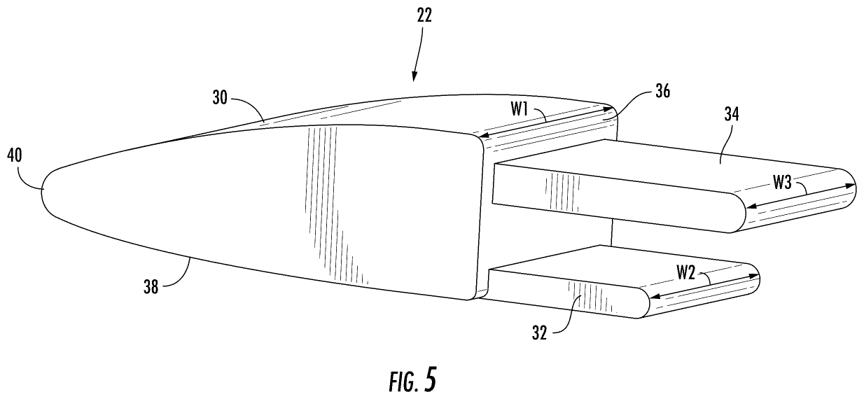

FIG. 4 depicts a side view of the insert 22. The insert 22 includes a ramp surface 30 configured to support the optical element 20 (as shown in FIG. 2). In one or more embodiments, the insert 22 includes a first tab 32 and a second tab 34. In one or more embodiments, the first tab 32 is configured to be inserted into the bore 26 of the second side 12b of distribution cable 12 (as shown in FIGS. 2 and 3B). In this way, the insert 22 is anchored into its position within the opening 18 of the distribution cable 12. In one or more embodiments, the second tab 34 is configured to maintain the gap G between the branch cable 14 and the distribution cable 12 during molding. In one or more embodiments, the second tab 34 is configured to provide a gap G of 1 mm to 2 mm between the branch cable 14 and the distribution cable 12. Thus, a distance D between the first tab 32 and the second tab 34 is selected based on the thickness of the cable jacket 24 of the distribution cable 12, and the thickness of the second tab 32 is selected to match the desired gap between the branch cable 14 and the distribution cable 12.

The first tab 32 has a first length L1, and the second tab 34 has a second length L2. In one or more embodiments, the first length L1 is equal to the second length L2. In one or more embodiments, including the embodiment shown in FIG. 4, the first length L1 is shorter than the second length L2. However, in one or more other embodiments, the first length L1 is longer than the second length L2. In one or more embodiments, the overmold 16 covers a length of the second side 12b of the distribution cable 12 and of the branch cable 14, and the second length L2 of the second tab 34 is about half the length of the cables 12, 14 covered by the overmold 16 or less.

As mentioned, the insert 22 is configured to maintain the desired position of components of the cable assembly 10 during molding, and thus, the insert 22 is positioned within the opening 18 of the distribution cable 12 prior to molding. To facilitate the molding process, the insert 22 also includes an abutment surface 36 that acts as a stop for the branch cable 14 when the branch cable 14 is inserted into the mold during molding. That is, the insert 22 also helps to ensure that the branch cable 14 is properly placed within the mold during molding so that the thermoplastic material is able to adequately seal around and bond to the end of the branch cable 14. In one or more embodiments, the abutment surface 36 is substantially perpendicular (e.g., forms an angle of 90°±10° with the second tab 34.

As shown in FIG. 4, the first tab 34 forms a substantially continuous surface with a bottom surface 38 of the insert 22. The bottom surface 38 of the insert 22 is configured to rest at least partially against the cable jacket 24 of the distribution cable 12 in the opening 18. In the embodiment shown in FIG. 4, the bottom surface 38 curves upwardly toward the ramp surface 30, and the bottom surface 38 transitions into the ramp surface 30 at curved end 40 of the insert 22. The insert 22 includes curved surfaces 30, 38 and end 40 to prevent sharp steps, which could create optical attenuation losses on the optical signals passing through the optical element 20.

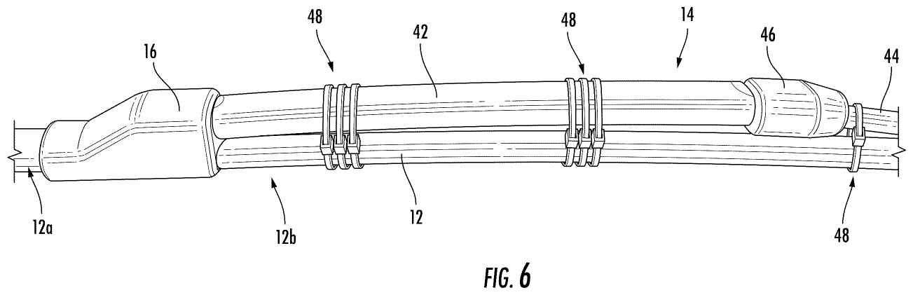

FIG. 5 depicts a perspective view of the insert 22. As can be seen, the ramp surface 30, the abutment surface 36, and the bottom surface 38 define a first width W1 of the insert 22. As mentioned, the first width W1 may be selected to allow the insert 22 to rest against the cable jacket 24 outside of the bore 26. In this regard, the first width W1 may be dependent upon the size of the distribution cable 12 in that a wider insert 22 may be used with a wider distribution cable 12. In one or more embodiments, the first width W1 is wider than the width of the bore 26 of the distribution cable 12 but no wider than the width of the distribution cable 12. The first tab 32 has a second width W2. In one or more embodiments, the second width W2 of the first tab 32 is selected to allow the first tab 32 to be inserted into the bore 26 of the second side 12b of the distribution cable 12. Thus, in one or more embodiments, the second width W2 is less than the first width W1. The second tab 34 has a third width W3. In one or more embodiments, the third width W3 is equal to or greater than the second width W2; however in one or more other embodiments, the third width W3 can instead be less than the second width W2. In an example embodiment, two branch cables 14 extend from the overmold 16, and the third width W3 of the second tab 34 may be greater than the second width W2 of the first tab 32 to provide sufficient support to maintain the gap G between the distribution cable 12 and the two branch cables 14.

In order to position the insert 22 within the opening 18, the shape of the first tab 32 can be changed to match the shape of the bore 26. As shown in FIG. 3B, the distribution cable 12 has a rectangular bore 26, and the first tab 32 may have a flat surface and sides to engage the bore 26 (e.g., as shown in FIG. 5). In one or more other embodiments, the distribution cable 12 may have a circular bore 26, and the first tab 32 may have a convexly curved upper surface to engage the bore 26.

In one or more embodiments, the insert 22 is molded from a polymer material. The polymer material may be any of a variety of materials capable of withstanding the molding temperature and pressures. In particular, the insert 22 should not melt, soften, or deform when exposed to the molten thermoplastic material of the overmold 16.

FIG. 6 depicts a wider view of the cable assembly 10. The cable assembly 10 includes the distribution cable 12, the branch cable 14, and the overmold 16 at the location where the branch cable 14 extends from the distribution cable 12. In one or more embodiments, the branch cable 14 includes a splice tube 42 that transitions to a tether 44. In one or more embodiments, the transition between the splice tube 42 and tether 44 is covered by a second overmold 46. In the cable assembly 10, the tether 44 includes an optical element 20 configured to communicate with an optical element 20 of the distribution cable 12. That is, a length of an optical element 20 is pulled from the distribution cable 12 at the opening 18 and spliced to the optical element 20 of the tether 44.

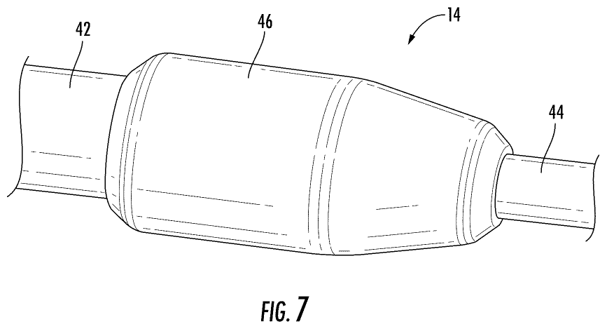

As shown in FIG. 7, the splice tube 42 has a first width, and the tether 44 has a second width. In one or more embodiments, the first width is different, in particular greater, than the second width. In this way, the splice tube 42 can be slid over the end of the tether 44. During splicing, the splice tube 42 is slid over the end of the tether 44 such that the tether 44 is within the splice tube 42. Further, during splicing, the optical element 20 extending from the tether 44 is spliced to the optical element 20 of the distribution cable 12. Thereafter, the splice tube 42 is slid back from its temporary storage position around the tether 44 to the location over the splice between the optical elements 20 to protect the splice and the optical elements 20 in the region between the opening 18 and the end of the tether 44.

Returning to FIG. 6, the splice tube 42 and the tether 44 are secured to the distribution cable 12. In one or more embodiments, a plurality of binders 48, such as cable ties, are provided around the splice tube 44 and the distribution cable 12 between the overmold 16 and the second overmold 46 and another binder 48 is provided around the tether 44 and the distribution cable 12 downstream of the second overmold 46. By securing the splice tube 42 against the distribution cable 12, the splice between the optical elements 20 of the distribution cable 12 and the tether 44 is protected from being stressed, twisted, or bent in a way that could break the splice or create attenuation. While FIG. 6 depicts a single branch point for the cable assembly 10, it should be noted that the cable assembly 10 can include multiple such branch points at a single overmold and/or along the length of the distribution cable 12 as needed to direct optical signals within an optical network.

Having described the cable assembly 10, the thermoplastic material of the overmold 16 and the second overmold 26 will now be described. According to the present disclosure, the thermoplastic material is selected to have one or more of the following characteristics: low melting temperature, high melt flow rate and good processability, balance between hardness and elastic modulus, strong adherence to the cable jackets, good low temperature performance, ultraviolet and chemical resistance, and strong mechanical properties.

In one or more embodiments, the thermoplastic material of the overmold 16, 46 has a high melt flow rate. In one or more embodiments, the melt flow rate is at least 4 g/10 min at 190° C., at least 10 g/10 min at 190° C., or at least 14 g/10 min at 190° C., as measured according to ASTM D 1238—Automatically Timed Flow Rate, Procedure B (21.6 kg standard weight). The high melt flow rate improves the processability during injection molding of thermoplastic material around the distribution cable 12. In particular, the high melt flow rate improves the flow of the molten thermoplastic material around the distribution cable 12 and the branch cable 14 within the injection molding apparatus.

Further, in one or more embodiments, the thermoplastic material of the overmold 16, 46 balances hardness and elastic modulus such that the thermoplastic material withstands deformation and external mechanical loads but is sufficiently flexible to support the branched cable assemblies from experiencing kinking. In one or more embodiments, the thermoplastic material has a hardness in the range of 60 to 95, in particular in the range of 85 to 88, as measured according to ASTM D2240-15 (Shore A, Instantaneous). Further, in one or more embodiments, the thermoplastic material has an elastic modulus in the range of 70 MPa to 250 MPa, in particular in the range of 100 MPa to 150 MPa, as measured according to ASTM D638-14.

Additionally, in one or more embodiments, the thermoplastic material is designed to adhere strongly to the cable jackets 24 of the distribution cable 12 and the branch cable 14. In this way, the overmold 16, 46 provides a strong seal against environmental contamination, especially water infiltration.

Still further, in one or more embodiments, the thermoplastic material of the overmold 16, 46 should be able to pass relevant cable standards such as Telcordia Generic Requirements, including GR-20-CORE and GR-3122-CORE. The GR-20-CORE requirements relate to outside plant cables and require good impact strength and crack resistance at low temperatures as well as UV and chemical resistance. The GR-3122-CORE standard relates to factory-installed termination systems and provides information regarding the ability of an overmold material to withstand conditions that can severely damage bonding between the cable jackets and the overmold material as heat and moisture cause material deformation and degradation which affect the bonding.

In one or more embodiments, the overmold 16, 46 is formed from a thermoplastic material including a polyolefin component and a thermoplastic polyolefin elastomer component. In one or more embodiments, the thermoplastic material of the overmold 16, 46 comprises the polyolefin component in an amount in a range of 30 wt % to 80 wt %. In one or more embodiments, the polyolefin component is selected from a group consisting of low-density polyethylene, medium-density polyethylene, high-density polyethylene, linear low-density polyethylene, and combinations thereof. In one or more embodiments, the thermoplastic material of the overmold 16, 46 comprises the thermoplastic polyolefin elastomer component in an amount in a range of 20 wt % to 70 wt %. In one or more embodiments, the thermoplastic polyolefin elastomer component is selected from a group consisting of an olefin block copolymer (e.g., INFUSE®), olefin random copolymer (e.g., Engage™), ethylene-propylene rubber (EPR), ethylene-propylene-diene rubber (EPDM), ethylene-octene (EO), ethylene-hexene (EH), ethylene-butene (EB), ethylene-vinyl acetate (EVA), ethylene acrylic acid (EAA), ethylene-butyl acetate (EBA), styrene-ethylene-butadiene-styrene (SEBS), and combinations of any two or more thereof.

In one or more embodiments, the thermoplastic material of the overmold 16, 46 includes up to 10 wt % of other processing and/or performance aids, including up to 3 wt % of carbon black, up to 1 wt % of a UV stabilizer (e.g., hindered amine light stabilizers), up to 3 wt % of an antifungal additive, and up to 3 wt % of other additives, such as color pigments, processing aids, or a functional filler.

A thermoplastic material according to the foregoing composition provides several advantages when used as an overmold 16, 46 of a cable assembly 10. In particular, the thermoplastic material has a low melting temperature, which is less than 200° C. and more particularly less than 150° C. Further, the thermoplastic material has low melt viscosity (or high melt flow rate) and good processability, making it suitable for low pressure (e.g., 250 psi or less) injection molding. The thermoplastic material is also particularly suitable for adhesion to typical polyethylene-based cable jacket materials. Still further, the thermoplastic material is suitable for use in low temperature conditions, having a glass transition temperature of −35° C. or less. Additionally, it is expected that the thermoplastic material is suitable for use not only at temperatures as low as −40° C. but also up to 95° C., and the thermoplastic material has good UV and chemical resistance. Also advantageously, the thermoplastic composition has a lower material cost than conventional polyurethane-based, thermosetting overmold compositions.

According to a first example embodiment, the thermoplastic material of the overmold 16, 46 includes 69 wt % LDPE (Agility™ 722, available from The Dow Chemical Company, Midland, MI), 24 wt % TPE (Infuse™ 9807, available from The Dow Chemical Company, Midland, MI), 6 wt % of an LDPE-based carbon black masterbatch (DFNA-0037BK, which includes 50 wt % loading of carbon black in Agility™ 722, available from The Dow Chemical Company, Midland, MI), and 1 wt % of zinc pyrithione (Zinc Omadine®, which includes 20 wt % loading of zinc pyrithione (ZnPT or bis(2-pyridylthio) zinc 1,1′-dioxide) in Agility™ 722).

The example thermoplastic material for the overmold 16, 46 had a density in the range of 0.91 to 0.92 g/cm³, a tensile stress at break in the range of 8 MPa to 10 MPa (in particular 8 MPa to 9 MPa), a tensile strain at break in the range of 500 to 600% (in particular 520% to 540%), a toughness in the range of 30 to 50 MPa, a melt flow rate in the range of 9.8 to 10.5 g/10 min at 190° C., and a Shore A hardness (instantaneous) in the range of 85 to 88. Additionally, it was determined that the peak melting temperature of the thermoplastic material of the overmold 16, 46 was in the range of 95° C. to 115° C.

According to another embodiment, the thermoplastic material of the overmold 16 is a polyethylene-based hot melt adhesive. A commercially available example of such a polyethylene-based hot melt adhesive is Technomelt® AS produced by Henkel Corporation (Düsseldorf, Germany). In one or more embodiments, the hot melt adhesive includes a low-molecular weight polyethylene and hydrotreated heavy naphthenic materials. Further, in one or more embodiments, the polyethylene-based hot melt adhesive may include various additives, such as carbon black, antifungal additives, fillers, viscosity modifiers, among others.

FIG. 8 provides a flow diagram of a method 100 for forming one or more overmolds 16 according to the present disclosure. In a first step 101 of the method 100, the distribution cable 12 is positioned within a mold. In particular, the opening 18 of the distribution cable 12 is positioned within a cavity of a mold for forming the overmold 16. In a second step 102 of the method 100, the insert 22 is positioned within the opening 18 of the distribution cable 12 such that the first tab 32 extends into the bore 26 of the second side 12b of the distribution cable 12. As mentioned above, this anchors the insert 22 into position within the mold. In a third step 103 of the method 100, the branch cable 14 is positioned within the mold such that the branch cable 14 abuts the insert 22 and the optical element 20 contacts the ramp surface 30. As described above, the branch cable 14 may abut the insert 22 in at least one of two ways, including against the second tab 34 (thereby providing the desired gap G for overmold 16 sealing) and against the abutment surface 36 (thereby ensuring that the overmold 16 surrounds a sufficient portion of the end of the branch cable 14). Further, as described above, the particular component of the branch cable 14 inserted into the mold may be a splice tube 42. In a fourth step 104, the thermoplastic material as described herein is injected into the mold to surround the opening 18 of the distribution cable 12 and the end of the branch cable 14, thereby forming the overmold 16.

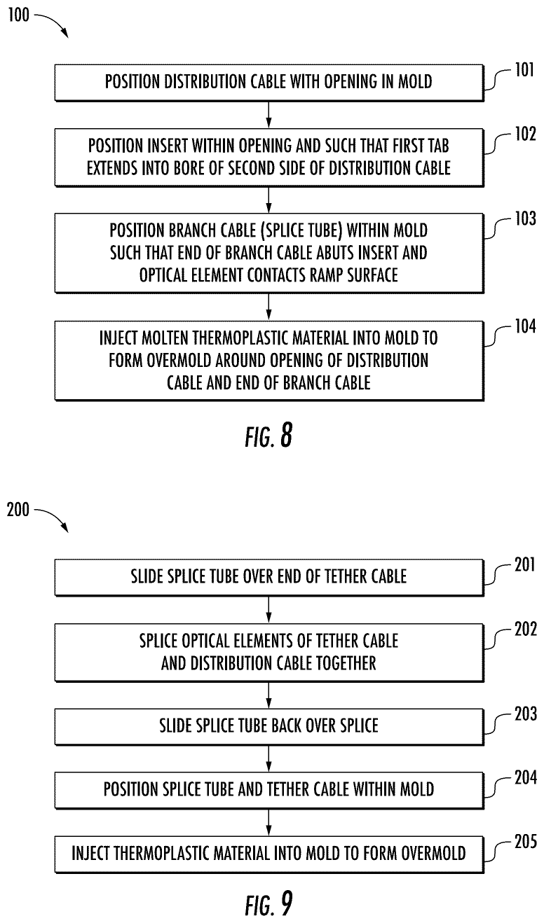

FIG. 9 provides a flow diagram of a second method 200 of forming the second overmold 46 around the splice tube 42 and tether 44 using the thermoplastic material as described herein. In a first step 201 of the method 200, a splice tube 42 is slid over an end of the tether 44. In a second step 202 of the method 200, an optical element 20 of the tether 44 is spliced to an optical element 20 of a distribution cable 12, e.g., using (mass) fusion splicing. In a third step 203 of the method 200, the splice tube 42 is slid back over the splice between the optical elements 20 of the distribution cable 12 and the tether 44. In one or more embodiments, the splice tube 42 may remain at least partially overlapped with the tether 44 such that a portion of the tether 44 remains within the splice tube 42. In a fourth step 204 of the method 200, the splice tube 42 and tether 44 are positioned within a mold, and in a fifth step 205 of the method 200, the thermoplastic material described herein is injected into the mold to form the second overmold 46 around the ends of the splice tube 42 and the tether 44. In embodiments in which the branch cable 14 includes a splice tube 42 and tether 44, the second method 200 to form the second overmold 46 may be performed prior to performing the first method 100 to form the overmold 16 around the opening 18 of the distribution cable 12 and end of the branch cable 14.

The thermoplastic material of the overmold 16, 46 provides many advantages over conventional thermosetting overmold materials, such as polyurethane. Such conventional overmold materials are comparatively more expensive and difficult to source than the disclosed thermoplastic material. Additionally, conventional overmold materials have a short pot life, leading to waste, and have a slow rate of cure, decreasing throughput. In contrast, the disclosed thermoplastic material for the overmold 16, 46 is widely available, easily sourced, and less expensive while also meeting all requirements for cable durability and environmental resistance. Further, when the insert 22 described above is used, the thermoplastic material can be low-pressure injection molded to form the overmold 16 around the distribution cable 12 and branch cable 14, sealing the distribution cable 12 and branch cable 14 against environmental contamination, without creating sharp bends in the optical element 20.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is in no way intended that any particular order be inferred. In addition, as used herein, the article “a” is intended to include one or more than one component or element, and is not intended to be construed as meaning only one.

It will be apparent to those skilled in the art that various modifications and variations can be made without departing from the spirit or scope of the disclosed embodiments. Since modifications, combinations, sub-combinations and variations of the disclosed embodiments incorporating the spirit and substance of the embodiments may occur to persons skilled in the art, the disclosed embodiments should be construed to include everything within the scope of the appended claims and their equivalents.

What is claimed is:

1. A cable assembly, comprising
a distribution cable containing a plurality of optical elements and having an opening formed in the distribution cable;
a branch cable having a bore extending along a length thereof;
an insert positioned in the opening of the distribution cable; and
a thermoplastic overmold;
wherein at least one optical element of the plurality of optical elements extends from the distribution cable through the opening and into the bore of the branch cable;
wherein the thermoplastic overmold is formed around the opening of the distribution cable, an end of the branch cable, at least a portion of the at least one optical element, and the insert;
wherein the insert creates a gap between the distribution cable and the branch cable so that the thermoplastic overmold fills the gap; and
wherein the insert comprises a ramp surface to support the at least one optical element in a transition from the opening into the bore of the branch cable.

2. The cable assembly of claim 1, wherein the insert comprises a first tab that is at least partially inserted into a second bore of the distribution cable.

3. The cable assembly of claim 2, wherein the insert comprises a second tab spatially disposed from the first tab and wherein the second tab is disposed between the distribution cable and the branch cable to create the gap between the distribution cable and the branch cable.

4. The cable assembly of claim 3, wherein the insert comprises an abutment surface substantially perpendicular to the second tab and wherein the end of the branch cable is abutted against the abutment surface.

5. The cable assembly of claim 2, wherein the insert comprises a first width defined by the ramp surface and a second width defined by the first tab and wherein the first width is wider than the second width.

6. The cable assembly of claim 1, wherein the thermoplastic overmold comprises from 30 wt % to 80 wt % of a polyolefin component and from 20 wt % to 70 wt % of a thermoplastic polyolefin elastomer component.

7. The cable assembly of claim 6, wherein the polyolefin component is selected from a group consisting of low-density polyethylene, linear low-density polyethylene, medium-density polyethylene, high-density polyethylene, and combinations thereof.

8. The cable assembly of claim 6, wherein the thermoplastic polyolefin elastomer component is selected from a group consisting of an olefin block copolymer, an olefin random copolymer, an ethylene-propylene rubber, an ethylene-propylene-diene rubber, an ethylene-octene, an ethylene-hexene, an ethylene-butene, an ethylene-vinyl acetate, an ethylene acrylic acid, an ethylene-butyl acetate, a styrene-ethylene-butadiene-styrene, and combinations thereof.

9. The cable assembly of claim 6, wherein the thermoplastic overmold further comprises an additive component in an amount of up to 10 wt %.

10. The cable assembly of claim 9, wherein the additive component is selected from a group consisting of carbon black, a UV stabilizer, an antifungal additive, a color pigment, a filler, a processing aid, and combinations thereof.

11. The cable assembly of claim 1, wherein the branch cable comprises a splice tube and a tether, the tether comprising a second optical element, wherein the at least one optical element is joined to the second optical element at a splice, wherein the splice tube covers the splice.

12. The cable assembly of claim 11, wherein the splice tube comprises the end of the branch cable and a second end distal from the end, wherein the tether comprises a third end, and wherein a second thermoplastic overmold is formed around the second end of the splice tube and the third end of the tether.

13. The cable assembly of claim 12, wherein one or more binders secure the splice tube against the distribution cable and wherein the one or more binders are disposed between the thermoplastic overmold and the second thermoplastic overmold.

14. A cable assembly, comprising
a distribution cable containing a plurality of optical elements and having an opening formed in the distribution cable;
a branch cable having a bore extending along a length thereof; and
an overmold;
wherein at least one optical element of the plurality of optical elements extends from the distribution cable through the opening and into the bore of a first end of the branch cable;
wherein the overmold is formed around the opening of the distribution cable, the first end of the branch cable, and at least a portion of the at least one optical element; and
wherein the overmold is formed from a thermoplastic material comprising 30 wt % to 80 wt % of a polyolefin component and 20 wt % to 70 wt % of a thermoplastic polyolefin elastomer component.

15. The cable assembly of claim 14, further comprising an insert positioned within the opening of the distribution cable, wherein the insert creates a gap between the distribution cable and the branch cable so that the overmold fills the gap and wherein the insert comprises a ramp surface to support the at least one optical element in a transition from the opening into the bore of the branch cable.

16. The cable assembly of claim 15, wherein the insert comprises a first tab that is at least partially inserted into the distribution cable downstream of the opening.

17. The cable assembly of claim 16, wherein the insert comprises a second tab spatially disposed from the first tab and wherein the second tab is disposed between the distribution cable and the branch cable to create the gap between the distribution cable and the branch cable.

18. A method of forming an overmold around a distribution cable and a branch cable in which a first optical element extends from the distribution cable into the branch cable, comprising:
positioning a distribution cable within a mold, the distribution cable containing a plurality of optical elements, including the first optical element, and the distribution cable having an opening formed therein through which the first optical element extends, the opening being within the mold;
positioning an insert within the opening;
positioning a branch cable within the mold such that an end of the branch cable abuts the insert and such that the first optical element contacts a ramp surface of the insert as the first optical element transitions from the opening to the branch cable; and
injecting a thermoplastic material into the mold to form the overmold around the opening of the distribution cable, the end of the branch cable, the insert, and at least a portion of the first optical element.

19. The method of claim 18, wherein the branch cable comprises a splice tube and a tether and wherein, prior to positioning the distribution cable within the mold, the method further comprises:
sliding the splice tube over an end of the tether;
forming a splice between a second optical element of the tether and the first optical element of the distribution cable;
sliding the splice tube over the splice;
positioning the splice tube and the tether in a second mold; and
injecting the thermoplastic material into the second mold to form a second overmold around respective ends of the splice tube and the tether.
